(19) United States
(12) Patent Application Publication
(10) Pub. No.: US 2013/0086911 A1
(43) Pub. Date: Apr. 11, 2013

(54) PROCESS AND APPARATUS FOR OVERLAY WELDING

(71) Applicants: Dechao Lin, Greer, SC (US); Srikanth Chandrudu Kottilingam, Simpsonville, SC (US); Yan Cui, Greer, SC (US); Ibrahim Ucok, Simpsonville, SC (US); Brian Lee Tollison, Honea Path, SC (US)

(72) Inventors: Dechao Lin, Greer, SC (US); Srikanth Chandrudu Kottilingam, Simpsonville, SC (US); Yan Cui, Greer, SC (US); Ibrahim Ucok, Simpsonville, SC (US); Brian Lee Tollison, Honea Path, SC (US)

(73) Assignee: GENERAL ELECTRIC COMPANY, Schenectady, NY (US)

(21) Appl. No.: 13/253,189

(22) Filed: Oct. 5, 2011

(51) Int. Cl. F02C 7/22; B23K 9/04

(52) U.S. Cl. 60/739; 219/76.14

(57) ABSTRACT

An apparatus and process for depositing an overlay weld on a substrate in a manner that reduces dilution of the substrate material. A consumable electrode is positioned in proximity to the surface of the substrate, and an electrical potential is applied between the electrode and substrate to generate an electrical arc therebetween. The arc melts the electrode and forms a molten spray that deposits on the substrate surface. Energy of the electric arc is absorbed to reduce the temperature at the substrate surface by feeding an additional filler material into the electric arc toward its center axis. The filler material continuously melts prior to reaching the center axis of the electric arc, and the electrode and filler materials are simultaneously deposited to form the overlay weld on the substrate. Sufficient energy is absorbed by the filler material to reduce intermixing between the overlay weld and the substrate.

### BACKGROUND OF THE INVENTION

The present invention generally relates to welding equipment and processes. More particularly, this invention relates to a welding apparatus and process for depositing an overlay weld such that mixing and dilution between the base metal and a deposited metal is reduced by reducing the depth of penetration of the deposited metal, and therefore the overlay weld, into the base metal.

Overlay welding generally involves depositing weld material over a surface region of a substrate. The weld material may be deposited as a series of beads, often with some lateral overlapping to form a continuous cladding layer of weld material that increases the thickness of the substrate, as well as properties such as strength. Overlay welds are utilized in a wide variety of applications, including but not limited to the fabrication and restoration of relatively large vessels and tubes used in industries such as utilities (including power generation), co-generation refining, petrochemical, pulp and paper, and waste-to-energy. Typical techniques for depositing overlay welds include shielded metal-arc welding, including gas tungsten arc welding (GTAW, or tungsten inert gas (TIG)), which uses a nonconsumable tungsten electrode, and gas metal arc welding (GMAW, or metal inert gas (MIG)), which uses a consumable electrode formed of the weld alloy to be deposited. These welding techniques involve the application of a sufficient electric potential between the electrode and substrate to be welded to generate an electric arc therebetween. Because the electrodes of GTAW techniques are not consumed, a wire of a suitable filler alloy must be fed into the arc, where it is melted and forms a metallic spray that deposits onto the substrate surface. In contrast, the consumable electrode of a GMAW technique serves as the source of filler material for the overlay weld.

A GMAW apparatus 10 is schematically represented in FIG. 1, and shows an electrical arc 12 generated between a consumable electrode 14 and a substrate 16 being welded. The arc 12 emanating from the electrode 14 causes the electrode 14 to melt and form a metallic spray 18, which deposits onto the weld zone defined by the projection of the arc 12 on the surface 20 of the substrate 16. Because the weld (not shown) is formed by the alloy of the electrode 14, electrodes used in GMAW processes are chosen on the basis of the compatibility of their alloy composition with the substrate material and the intended application, for example, whether the overlay weld is intended to improve the wear, corrosion or other properties of the substrate.

Overlay welding processes typically must comply with a wide range of specifications, such as minimal weld penetration and deposit thickness, low dilution, complete fusion, homogeneous deposits, and very low heat input. As such, the reinforcement or repair of a substrate with an overlay weld can be complicated by the desire to reduce intermixing of the overlay weld material with the substrate material, in contrast to certain welding methods where intermixing is desirable. As a nonlimiting example, manifolds of fuel systems for gas turbine engines are often formed of nickel-base alloys, and the fabrication and repair of such manifolds with an overlay weld is preferably achieved so that minimal intermixing occurs between the nickel-base alloy of the manifold and the alloy used to form the overlay weld. Excessive intermixing of these alloys causes localized dilution of the nickel-base alloy of the manifold, which can reduce the properties of the manifold. FIG. 2 is a microphotograph of an overlay weld formed by a conventional GMAW process that resulted in considerable penetration by the weld into a substrate, resulting in a dilution zone that penetrated the substrate surface by a depth (d) of about 1 to 4 mm. It is generally understood that the relatively large size of the dilutions zone in FIG. 2 is attributable to the high heat input associated with GMAW techniques.

Laser beam welding (LBW) techniques are known to be capable of achieving significantly reduced weld penetration as a result of their lower heat inputs. However, a drawback of LBW is that deposition rates tend to be very low and LBW equipment can be cost prohibitive. As an alternative solution, GMAW processes have been developed that involve a pulsed arc technique to reduce the heat generated by the arc. An example of an overlay weld formed by such a process is represented in FIG. 3, in which a reduced dilution zone has been formed, roughly penetrating the substrate surface by a depth (d) of about 0.025 inch (about 0.65 mm). Though significantly less than the weld penetration evidenced in FIG. 2, the penetration seen in FIG. 3 can still be excessive, for example, in the aforementioned manifold application. On the other hand, any reduction in intermixing should be achieved with minimal negative impact on the bond strength between the overlay weld and the substrate.

### BRIEF DESCRIPTION OF THE INVENTION

The present invention provides an apparatus and process for depositing an overlay weld on a substrate in a manner that reduces dilution of the substrate material, yet yields a strong bond between the overlay weld and substrate.

According to a first aspect of the invention, an apparatus is provided for depositing an overlay weld on a surface of a substrate formed of a substrate material. The apparatus includes a consumable electrode formed of a first metallic material and adapted to be positioned in proximity to the surface of the substrate, and means for applying an electrical potential between the electrode and the substrate that is sufficient to generate an electrical arc that is between the electrode and the substrate. The arc has a center axis and an outer diameter surrounding the center axis at the surface of the substrate, and has sufficient energy to melt the electrode and form a molten spray of the first metallic material that deposits on the surface of the substrate. The apparatus further includes means for flowing a shielding gas around the electric arc, and means for absorbing energy of the electric arc to reduce a temperature at the surface of the substrate. The energy absorbing means includes a second metallic material and means for feeding the second metallic material into the electric arc and toward the center axis of the electric arc. The feeding means being adapted to cause the second metallic material to be fed so that an end thereof continuously melts prior to the end reaching the center axis of the electric arc.

According to a second aspect of the invention, a process is provided for depositing an overlay weld on a surface of a substrate formed of a substrate material. The process includes positioning a consumable electrode of a first metallic material in proximity to the surface of the substrate, and then applying an electrical potential between the electrode and the substrate that is sufficient to generate an electrical arc that is between the electrode and the substrate, melts the electrode, forms a molten spray of the first metallic material, and deposits the molten spray on the surface of the substrate. The electric arc is generated and maintained to have a center axis and an outer diameter surrounding the center axis at the surface of the substrate. While a shielding gas flows around the electric arc, energy of the electric arc is absorbed to reduce the temperature at the surface of the substrate by feeding a second metallic material into the electric arc and toward the center axis of the electric arc. The second metallic material is fed so that an end thereof continuously melts prior to the end reaching the center axis of the electric arc, so that the first and second metallic materials are simultaneously deposited to form the overlay weld on the surface of the substrate. The second metallic material sufficiently absorbs energy of the electric arc so that the first and second metallic materials of the overlay weld intermix with the substrate material to form a fusion depth of less than 0.5 mm beneath the surface of the substrate.

Other aspects of the invention include substrates that have been welded using processes and apparatuses of the type described above. A particular but nonlimiting example is the fabrication or repair of a manifold of a fuel system for a gas turbine engine.

A technical effect of this invention is the ability to deposit a weld overlay that has minimal dilution with the underlying substrate, generally similar to weld overlays produced by laser beam welding (LBW) methods, but at higher deposition rates associated with arc welding techniques and without the relatively high investment costs of LBW equipment.

Other aspects and advantages of this invention will be better appreciated from the following detailed description.

### BRIEF DESCRIPTION OF THE DRAWINGS

FIG. 1 is a schematic representation of an overlay welding apparatus and process that makes use of a consumable electrode in accordance with the prior art.

FIGS. 2 and 3 are microphotographs of overlay welds produced with welding apparatuses of the type represented in FIG. 1.

FIG. 4 is a schematic representation of an overlay welding apparatus and process that makes use of a consumable electrode and an additional filler material in accordance with an embodiment of the present invention.

FIG. 5 is a microphotograph of an overlay weld produced with the apparatus and process represented in FIG. 4.

FIG. 6 is a microphotograph of an overlay weld deposited using an overlay welding apparatus and process of the type represented in FIG. 1, and FIGS. 7 through 9 are microphotographs of overlay welds deposited using an overlay welding apparatus and process of the type represented in FIG. 4 and using various feed rates for the additional filler material.

FIG. 10 is a graph that plots fusion area (weld penetration) versus wire feeding rate for the overlay welds of FIGS. 6 through 9.

### DETAILED DESCRIPTION OF THE INVENTION

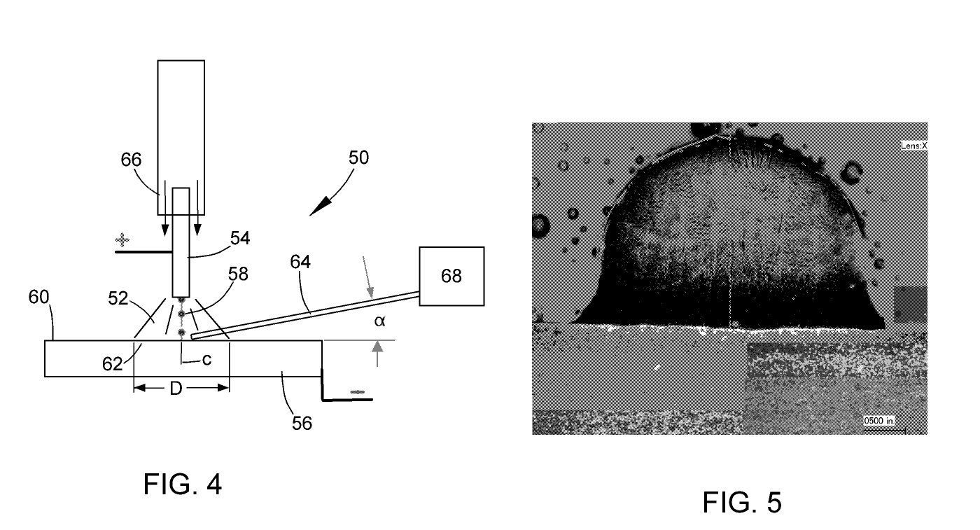

The present invention provides the capability of reducing the depth of penetration of an overlay weld produced by an arc welding process that uses a consumable electrode, a particular example of which is GMAW (MIG). An example of a welding apparatus suitable for use with the invention is schematically represented as a GMAW apparatus 50 in FIG. 4, though it should be understood that the invention can be extended to other arc welding processes that utilize an electrode that is consumed during the overlay welding process. In addition, the invention is generally applicable to welding a wide variety of materials, including nickel-, cobalt- and iron-base superalloys, stainless steels, carbon steels, Cr—Mo steels, low-alloy steels, etc.

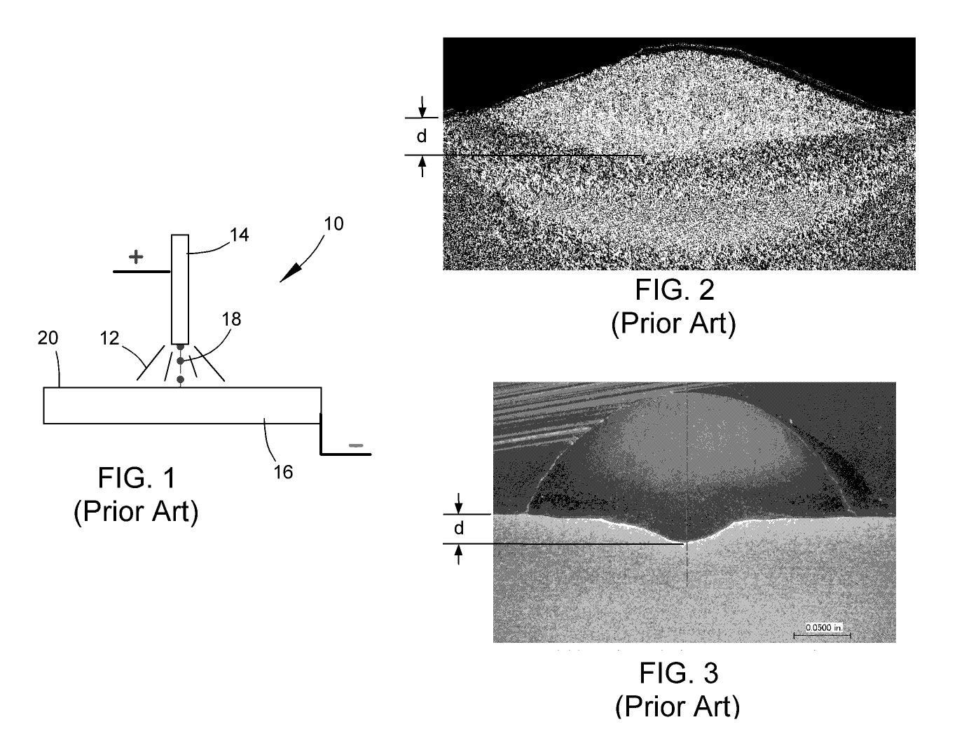

Similar to the prior art apparatus 10 of FIG. 1, the apparatus 50 of FIG. 4 is schematically represented as generating an electrical arc 52 between a consumable electrode 54 and a substrate 56 to be welded. As known in the art, a suitable welding power source (not shown) for use in a GMAW method provides a constant voltage and direct current, and when coupled to the electrode 54 and substrate 56 generates the arc 52. The arc 52 emanating from the consumable electrode 54 causes the electrode 54 to melt and form a metallic spray 58 that deposits onto a weld zone 62 defined by the projection of the arc 52 onto the surface 60 of the substrate 56. As such, the electrode 54 serves as a source of filler material for the weld (not shown) produced by the overlay welding process. FIG. 4 further represents the apparatus 50 as including a torch 66 through which a flowing shielding gas (as an example, argon) flows for the purpose of shrouding the arc 52 and metallic spray 58 from the surrounding atmosphere.

As evident from FIG. 4, the invention further makes use of at least one additional source of metallic filler material, in addition to the metallic filler material provided by the electrode 54 from which the arc 52 emanates. The additional filler material is represented in FIG. 4 as a single wire 64, though it should be understood that the invention is not limited to one additional filler material in wire form, and that additional welding consumables in other forms could be used, for example, including powders and/or additional wires. In contrast to the electrode 54, an arc is not struck between the wire 64 and the substrate 56. As such, the wire 64 can be referred to as a cold wire 64, in other words, the wire 64 does not contribute to the heat generated by the welding process. Instead, the wire 64 is fed into the arc 52 toward the center (c) thereof for the purpose of absorbing some of the energy of the arc 52, with the result that, under otherwise identical operating conditions, the substrate 56 heated by the arc 52 in FIG. 4 will be at a lower temperature than the substrate 16 heated by the arc 12 in FIG. 1. Notably, the shielding gas flowing from the torch 66 also shrouds the tip of the cold wire 64 from the surrounding atmosphere.

According to a preferred aspect of the invention, sufficient energy is absorbed by the wire 64 to result in a more uniform temperature profile at the substrate surface 60, resulting in a more uniform fusion profile and very little penetration of the resulting overlay weld (not shown) beneath the surface 60. Such a result can be seen in FIG. 5, which is a microphotograph of an overlay weld formed by a GMAW process that was modified in accordance with FIG. 4 to introduce a cold wire 64 into the arc 52, which resulted in a greatly reduced dilution zone as compared to the dilution zones represented in FIGS. 2 and 3. In particular, the dilution zone in FIG. 5 roughly penetrates the substrate surface by a depth (d) of about 0.004 inch (about 0.1 mm), and is therefore far less than the weld penetrations evidenced in FIGS. 2 and 3. Though a significant reduction in intermixing was achieved, nothing was evident from the overlay weld that would indicate that the bond strength between the overlay weld and the substrate was negatively impacted.

The cold wire 64 is portrayed in FIG. 4 as being fed into the arc 52 at an acute angle, a, to the surface 60 of the substrate 66. The tip of the wire 64, at which melting occurs, preferably does not completely extend to the center (c) of the arc 52, but instead is located radially outward away from the center (c) by a distance sufficient to avoid arc instability that might otherwise occur. On the other hand, the wire 64 sufficiently penetrates the diameter (D) of the arc 52 so that the tip of the wire 64 is in close proximity to the weld zone 62 defined by the projection of the arc 52 on the surface 60 of the substrate 56. The tip of the wire 64 is preferably at least 0.5 mm from the center (c) of the arc 52, and more preferably 0.5 to about 1.0 mm from the center (c). The angle, a, at which the wire 64 is fed into the arc 52 can vary, though particularly suitable angles are believed to about 15 to about 65 degrees from the surface 60 of the substrate 56 so that the wire 64 and its delivery into the arc 52 do not disturb the arc 52.

From the above, it can be further appreciated that the arc welding process represented in FIG. 4 involves the melting of three (or more) materials at the same time. These materials, namely, those of the electrode 54, substrate 56 and cold wire 64, may all be different or have the very same composition, in other words, within the targeted ranges for a specific alloy. In practice, the alloys of the electrode 54 and cold wire 64 will typically differ from that of the substrate 56, since the desired overlay weld will often be intended to improve one or more properties of the substrate 56, for example, wear resistance, corrosion resistance, erosion resistance, etc., and therefore will be formed of a material that is superior to the substrate in terms of at least one property, for example, exhibits greater wear, corrosion and/or erosion resistance, than of the substrate. Furthermore, the properties desired for the substrate 56 may not be compatible with the properties required of the electrode 54 and cold wire 64, particularly in view of the necessity that the electrode 54 and wire 64 melt through the action of the arc 52. On the other hand, the overlay weld, and therefore the alloys of the electrode 54 and wire 64 that form the weld, should be formulated to have certain physical and mechanical properties that are similar to the alloy of the substrate 56. To this extent, the alloys of the electrode 54, wire 64 and substrate 56 will often have the same base element, for example, nickel, in which case each of the alloys contains more nickel by weight (or possibly atomic percent) than any other individual constituent of the alloy. The alloys of the electrode 54, wire 64 and substrate 56 may also contain similar amounts of the same base element, as well as contain similar amounts of any major alloying constituents, for example, chromium in a nickel-base alloy. In most cases, the alloys of the electrode 54 and wire 64 will differ from that of the substrate 56, for example, as a result of containing constituents that contribute desirable properties to the electrode 54, wire 64 and the resulting overlay weld, and/or containing melting point suppressants such as boron and/or silicon, and/or lacking constituents found in the substrate 56, for example, gamma-prime formers such as aluminum and/or titanium.

Various factors influence the heat input to the substrate 56 resulting from the arc 52, which in turn is dependent on the welding power supplied to generate the arc 52. The amount of energy (heat) that can be absorbed by the cold wire 64 will depend on the feed rate and size (diameter) of the cold wire 64. Under typical circumstances, suitable diameters for the wire 64 will generally be in a range of about 0.5 to about 1.5 mm. For welding power conditions typical for GMAW techniques, suitable feed rates for the wire 64 are believed to be at least twenty inches per minute (at least 50 cm/minute), and more preferably greater than sixty inches per minute (greater than 150 cm/minute). Feed rates can be controlled with a wire feed motor 68 of a type known in the art.

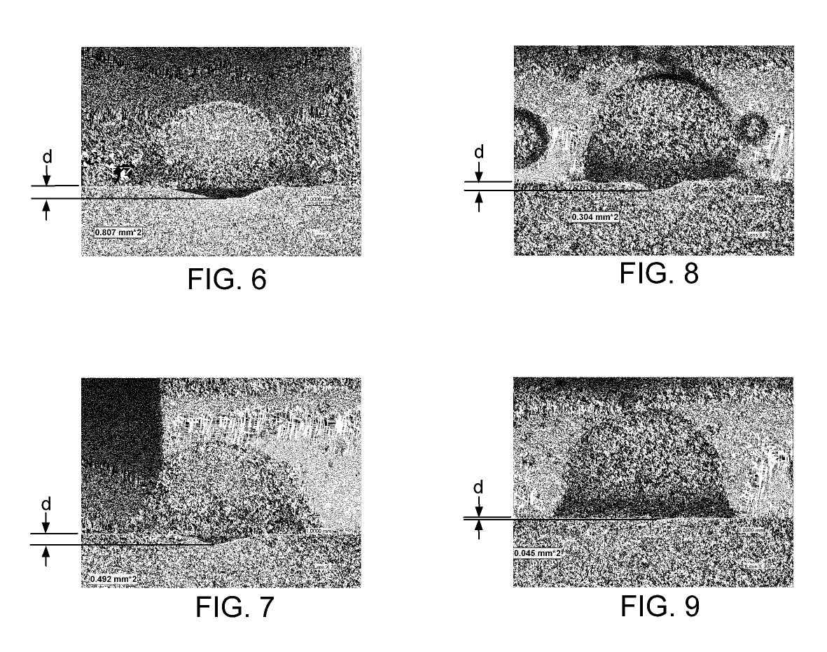

In an investigation leading to the present invention, a GMAW welder was employed to deposit overlay welds on substrates formed of Type 304 stainless steel. The welder was operated at conditions that included a voltage of about 20V and a welding current of about 100 A, which resulted in an arc power of about 2 kW. Electrodes used in the welding process were formed of Inconel 625, a well-known solid solution-strengthened nickel-base superalloy. In a first trial, the welder was operated in the manner schematically represented in FIG. 1. A microphotograph in FIG. 6 shows a cross-section of the resulting overlay weld, and evidences that the dilution zone roughly penetrated the substrate surface by a depth (d) of about 0.5 mm, yielding a fusion area (cross-sectional area of the dilution zone) of about 0.807 mm².

FIG. 7 represents the results of another trial that used the same welder operated under the same power conditions, but modified to introduce a cold wire into the arc similar to what is schematically represented in FIG. 4. The cold wire was also formed of Inconel 625, had a diameter of about 1.2 mm, and was fed at a rate of about 22.5 inch/minute (about 57.1 cm/minute). FIG. 7 is a microphotograph showing a cross-section of the resulting overlay weld, and evidences that the dilution zone roughly penetrated the substrate surface by a depth (d) of about 0.4 mm, yielding a fusion area of about 0.492 mm². Finally, FIGS. 8 and 9 (the latter shows the same weld shown in FIG. 5) are microphotographs of overlay welds produced under the same conditions as that used to produce the overlay welds of FIGS. 6 and 7, but with higher wire feed rates of about 45.0 and 67.5 inch/minute (about 114 and about 171 cm/minute), respectively. FIGS. 8 and 9 evidence that the dilution zones roughly penetrated their respective substrate surfaces by depths (d) of about 0.3 mm and about 0.1 mm, respectively, yielding fusion areas of about 0.304 mm² and about 0.045 mm², respectively.

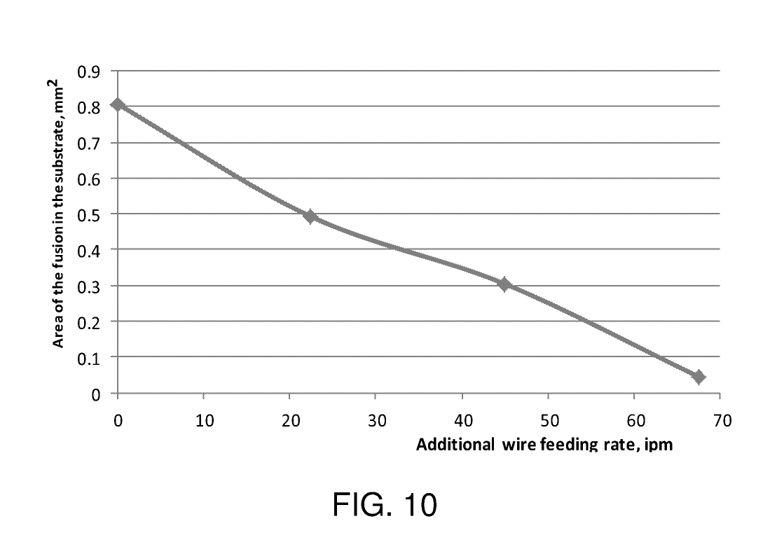

FIG. 10 is a graph correlating the fusion area versus the cold wire feed rate (in inch/minute) of the four trials shown in FIGS. 6 through 9. As evident from FIG. 10, the fusion area is roughly inversely proportional to the wire feed rate. At feed rates above 22.5 inch/minute (about 57.1 cm/minute), the fusion area is 0.5 mm² or less, which is believed to be sufficiently small to have little impact on the properties of the substrate, and feed rates of about 62.5 inch/minute (about 160 cm/minute) and higher are predicted to have fusion areas of less than 0.1 mm², and therefore believed to have negligible impact on the properties of the substrate. From the data, it was concluded that wire feed rates of at least twenty inches per minute (at least 50 cm/minute) are believed to be suitable, and wire feed rates of greater than 60 inch/minute (greater than 150 cm/minute) are believed to be preferred.

From the results reported above, it was concluded that overlay welds produced with the present invention are capable of exhibiting qualities similar to those achieved by laser beam welding, but at substantially lower costs in terms of equipment costs, and with significantly higher deposition rates as compared to laser beam welding.

While the invention has been described in terms of a particular embodiment, it is apparent that other forms could be adopted by one skilled in the art. Therefore, the scope of the invention is to be limited only by the following claims.

1. An apparatus for depositing an overlay weld on a surface of a substrate formed of a substrate material, the apparatus comprising:
a consumable electrode formed of a first metallic material and adapted to be positioned in proximity to the surface of the substrate;
means for applying an electrical potential between the electrode and the substrate that is sufficient to generate an electrical arc that is between the electrode and the substrate, has a center axis and an outer diameter surrounding the center axis at the surface of the substrate, and has sufficient energy to melt the electrode and form a molten spray of the first metallic material that deposits on the surface of the substrate;
means for flowing a shielding gas around the electric arc; and
means for absorbing energy of the electric arc to reduce a temperature at the surface of the substrate, the energy absorbing means comprising a second metallic material and means for feeding the second metallic material into the electric arc and toward the center axis of the electric arc, the applying means and the feeding means being adapted to cause an end of the second metallic material to continuously melt prior to reaching the center axis of the electric arc.

2. The apparatus according to claim 1, wherein the first and second metallic materials have different compositions.

3. The apparatus according to claim 1, wherein the first and second metallic materials have the same composition.

4. The apparatus according to claim 1, wherein the first and second metallic materials exhibit greater wear resistance, corrosion resistance, and/or erosion resistance than the substrate material.

5. The apparatus according to claim 1, wherein the end of the second metallic material is at least 0.5 millimeters from the center axis of the electric arc.

6. The apparatus according to claim 1, wherein the second metallic material is a wire disposed at an angle of about 15 to about 65 degrees from the surface of the substrate.

7. A process of depositing an overlay weld on a surface of a substrate formed of a substrate material, the process comprising:
positioning a consumable electrode of a first metallic material in proximity to the surface of the substrate;
applying an electrical potential between the electrode and the substrate that is sufficient to generate an electrical arc that is between the electrode and the substrate, melts the electrode, forms a molten spray of the first metallic material, and deposits the molten spray on the surface of the substrate, the electric arc being generated and maintained to have a center axis and an outer diameter surrounding the center axis at the surface of the substrate;
flowing a shielding gas around the electric arc; and
absorbing energy of the electric arc to reduce a temperature at the surface of the substrate by feeding a second metallic material into the electric arc and toward the center axis of the electric arc, the second metallic material being fed so that an end thereof continuously melts prior to the end reaching the center axis of the electric arc so that the first and second metallic materials are simultaneously deposited to form the overlay weld on the surface of the substrate, the second metallic material sufficiently absorbing energy of the electric arc so that the first and second metallic materials of the overlay weld intermix with the substrate material to form a fusion depth of less than 0.5 mm beneath the surface of the substrate.

8. The process according to claim 7, wherein the first and second metallic materials of the overlay weld intermix with the substrate to form a fusion depth of not more than 0.1 mm beneath the surface of the substrate.

9. The process according to claim 7, wherein the first and second metallic materials of the overlay weld intermix with the substrate to form a fusion area of less than 0.5 mm² beneath the surface of the substrate.

10. The process according to claim 7, wherein the first and second metallic materials of the overlay weld intermix with the substrate to form a fusion area of less than 0.1 mm² beneath the surface of the substrate.

11. The process according to claim 7, wherein the substrate material and the first and second metallic materials are chosen from the group consisting of nickel-base superalloys, cobalt-base superalloys, iron-base superalloys, stainless steels, carbon steels, Cr—Mo steels, low-alloy steels.

12. The process according to claim 11, wherein the first and second metallic materials have different compositions.

13. The process according to claim 11, wherein the first and second metallic materials have the same composition.

14. The process according to claim 11, wherein the first and second metallic materials exhibit greater wear resistance, corrosion resistance, and/or erosion resistance than the substrate material.

15. The process according to claim 7, wherein the second metallic material is fed into the electric arc at a rate of at least 50 centimeters per minute.

16. The process according to claim 7, wherein the second metallic material is fed into the electric arc at a rate of greater than 150 centimeters per minute.

17. The process according to claim 7, wherein the second metallic material is fed into the electric arc at a rate of about 57.1 to about 171 centimeters per minute.

18. The process according to claim 7, wherein the end of the second metallic material is continuously melted at least 0.5 millimeters from the center axis of the electric arc,

19. The process according to claim 7, wherein the substrate is a manifold of a fuel system of a gas turbine engine.

20. The manifold of claim 19.
